(19) United States
(12) Patent Application Publication
(10) Pub. No.: US 2007/0208523 A1
(43) Pub. Date: Sep. 6, 2007

(54) Device and Method for Determining the Quality of Illustrations of Printing Plates

(75) Inventors: Helmut Britsch, Friesenheim (DE); Oswald Grutter, Teufen (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: Bruder Neumeister GmbH, Lahr (DE)

(21) Appl. No.: 10/590,469

(22) PCT Filed: Feb. 16, 2005
(86) PCT No.: PCT/EP05/01547

§ 371 Date: Aug. 23, 2006

(30) Foreign Application Priority Data
Feb. 24, 2004 (DE) 10 2004 009 390.3

(51) Int. Cl. G06F 19/00

(52) U.S. Cl. 702/83

(57) ABSTRACT

A device and a method for determining the quality of imaging of printing plates by means of, in particular, an optoelectronic sensor for detecting a reference mark that is disposed inside or outside the printing area which includes different reference fields is provided. An evaluation unit is provided for evaluating the measured values determined by the sensor. The sensor is configured to detect at least two reference marks located on the printing plate. Each of the reference marks includes a combination of reference fields having at least one tone value reference field and at least one structured reference field, or at least one reference mark includes at least one tone value reference field while at least one additional reference mark includes at least one structured reference field.

### BACKGROUND

The invention relates to a device and to a method for determining the quality of illustrations of printing plates by means of, in particular, an optoelectronic sensor for detecting a reference mark that is disposed inside or preferably outside the printing area and that comprises different reference fields. An evaluation unit is provided for evaluating the measured values determined by the sensor.

Printing plates, as a rule, comprise a carrier, for example, aluminum, a printing layer, for example, plastic or polymer, etc., as a printing surface and a heat-sensitive or light-sensitive layer. The printing plate is imaged and the printing layer is partially removed in a developer, in order to obtain the desired plate imaging. Here, the imaging unit, the illumination unit, and also the developer and other system components must contain exact operating parameters, in order to achieve good quality for the plate imaging. These operating parameters are also dependent on the type of printing plates. Thus, for example, photopolymers, thermal, silver, positive or negative printing plates are known, which are processed differently, for example, they must be illuminated and developed for different lengths of time. For inadequate operating parameters, the quality of the plate imaging of the printing plate can be reduced, whereby the printing can be unclean, non-uniform, or unsatisfactory in some other way. It is also possible that the printing plate is usable only for a small number of printing runs and wears out prematurely.

Therefore, devices of the type noted above are already known for determining quality of the plate imaging of a printing plate. Here, a reference mark, a so-called wedge or measuring wedge, is brought onto the printing plate and illuminated and developed together with the other plate imaging. The reference mark of the final printing plate is detected with a sensor, for example, a camera, and evaluated in an evaluation device. Typically, the reference mark has several reference fields with different tone values. The tone values each have a known desired value. If the measured tone values of the reference mark differ from the desired values, this is an indication of an inadequate quality of the printing plate. An operator can then change the operating parameters of the printing plate processing device, in order to raise the quality of the final printing plates.

However, the measured values give no indication on the cause of the reduced quality. The cause can be, for example, an illuminating intensity of an illuminating laser that is too strong or too weak, a drift in the focus of the illuminating laser, a non-optimized development period, or the like. Therefore, the operator must change one of the operating parameters and in another step check whether the quality of the plate imaging was improved by these measures and if necessary change other parameters until the desired result is achieved. This is laborious and time-intensive. In addition, if necessary, several printing plates must be produced as tests, which do not satisfy the quality requirements and thus produce waste, which generates unnecessary costs, during the setup process of the printing plate processing device. In addition, the measurement and the possibly necessary adjustment of the printing plate processing device typically can be performed only with spot checks, for example, three times a day, due to the time required for these checks.

### SUMMARY

Therefore, there is, in particular, the objective of creating a device of the type noted above, which enables an improved quality determination and especially a conclusion on the cause of a quality that is too low. In addition, a continuous quality determination should be able to be realized.

The solution to meeting this objective according to the invention is provided, in terms of the device, in that the sensor is designed for detecting at least two reference marks (wedge or block) arranged on the printing plate, with the reference marks each having a reference field combination made from at least one tone value reference field and at least one structured reference field, or at least one reference mark has at least one tone value reference field, and at least one other reference mark has at least one structured reference field.

The measured values of the tone value reference fields on one hand and the structured reference fields on the other hand enable a measured value analysis, which permits the causes to be reduced to a precise conclusion on the cause of a possible lack of quality. Thus, the printing plate processing device can be modified selectively, in order to improve the quality of the plate imaging.

The structured reference fields are pixel-based (preferably micro) elements, with a pixel being defined by the smallest viewable unit of the printing plate processing device. The structures, for example, line, stripe, or point systems or the like, are given by pixel arrangements of pixels with at least two different tone values or geometric structures. Here, the tone values of 0% (white) and 100% (black) are preferably used. However, instead of black, other tone values or also pixels of separated colors, for example, magenta, yellow, or cyan, are also possible.

The use of at least two reference marks increases the ability to reach a conclusion on the determined measured values. In addition, several reference marks and/or taking several reference fields into consideration at the same time enables a mutual plausibility check.

A preferred embodiment of the device according to the invention provides that two reference marks are provided, which are arranged at a distance from each other in the direction of advance or processing of the printing plate processing device generating the plate imaging, preferably on at least approximately diagonally opposite areas of the printing plate. Therefore, an improved quality check is possible. With only one reference mark, only the quality at this position can be determined. However, it is possible that the quality of the plate imaging is sufficiently good at one measurement position but worsens along the processing direction of the printing plate processing device. Such changes in quality can be detected and analyzed with several reference marks in the described arrangement. Here, in the preferred embodiment with reference marks arranged approximately diagonally from each other, a check can be performed both in the processing direction of the printing plate and also in the transverse direction.

The detection of the reference marks can be performed with a single sensor, for example, a camera. For this purpose, the sensor can be positioned initially at one of the reference marks and, after detecting the measured values, it can be positioned at the other reference mark(s), in order to detect the other measured values. However, this is complicated and time-intensive.

Therefore, it is useful when the sensor has a number of detectors corresponding to the number of reference marks of a printing plate. The detectors can record their measured values at the same time and transmit these values to the evaluation device, which reduces the time span for detecting all of the reference marks. In addition, the sensor must be aligned only once, because with this one alignment, all of the detectors are positioned relative to the appropriate reference mark.

It is especially advantageous when the evaluation device is designed for combining the measured values of individual reference fields that are preset or that can be preset for one or more reference marks and when the evaluation device has preferably a diagnosis system for diagnosing possible causes for defects depending on the measured values or the combination of measured values.

By taking several reference fields into consideration in combination with each other, an especially precise conclusion can be made on the causes of a lack of quality. For example, poor measured values for two structured reference fields in connection with a good measured value for one tone value reference field can permit a conclusion to be made for inadequate focusing of the illumination source, for example, an illuminating laser. Similar links can be made in the evaluation device in a diagnosis system, so that a precise analysis and diagnosis of the measured values can be output to an operator and a specific intervention in the printing plate processing device is possible for improving the quality of the plate imaging. Such an expert system as an interface between the device and an operator thus considerably increases the efficiency of the device according to the invention.

Here, it is useful when the evaluation device has a display or similar output unit for displaying the measured values or, in particular, analysis or diagnosis data determined by the output unit with reference to the measured values. Thus, an operator directly receives analysis data determined by the evaluation device in an understandable form, so that no special knowledge is necessary for understanding the measured values and a quick intervention in possible in the case of the appearance of poor quality.

The data can also be output via a printer as an output unit.

One advantageous embodiment provides that the evaluation device has a data memory for the determined measured values and/or the analysis data determined from these values. This enables, in particular, the creation of history data, that is, an analysis of the changes in the measured values over a longer period of time. In this way, information on the quality of the printing plate processing device can also be obtained. In addition, the measured values can also be archived.

The measured values or the interpretation of the measured values can be dependent on the type of printing technology that is used, for example, on the type of plates, the illumination, and/or the development, so that different printing technologies require different interpretations of the measured values. Therefore, it is useful when the evaluation device has a desired value memory for different printing technologies and an input device for the selection and setting of desired values to be used by the evaluation device. The device according to the invention can thus be configured for different printing plate processing devices via the input device as a user interface.

The device according to the invention can be embodied as a standalone device, in which the final printing plates are inserted, in particular, manually. This enables an operation of the device independent of the printing plate processing equipment that is used.

However, it is also possible advantageously that the device is integrated into a printing plate processing device. Here, for example, a manual transfer of the printing plates for the quality check is not required, which increases the operating speed. In addition, using simple and fast means, all of the processed printing plates can be checked, so that a complete series of measurements over the entire production process can be performed. The device according to the invention can be provided, in particular, in a device for setting the stamping marks of the printing plate processing device. When the stamping marks are set, the printing plate is aligned precisely with reference to marks, such as positioning crosses, on the printing plate. Thus, a repeated alignment of the printing plate for the quality measurement is not required.

It can be useful when the evaluation device has a signal output connected to the printing plate processing device for stopping the printing plate processing device. If the analysis of the measured values gives the result that the quality of the plate imaging of the printing plates is too poor, the processing device can be stopped automatically, in order to avoid further defective production and thus to save costs.

The invention also relates to a method for determining the quality of the imaging of printing plates, in which a reference mark on the printing plate is detected optically and the resulting measured values are compared with desired values. The method according to the invention is characterized in that the measured values are detected from at least two reference marks with tone value fields and structured fields and that the absolute measured values of the reference marks are stored and compared with desired values stored in an evaluation device.

The advantages of the method according to the invention emerge from the above description of the device according to the invention.

The invention also relates to a reference mark with different reference fields for determining the quality of printing plates, as well as to printing plates with corresponding reference marks. The reference mark according to the invention is characterized by a reference field combination made from at least one tone value field and at least one structured field.

### BRIEF DESCRIPTION OF THE DRAWINGS

Other preferred embodiments emerge from the subordinate claims and also the drawings described below.

Shown are, partially in schematic representation:

FIG. 1 a flow chart of the method according to the invention,

FIG. 2 a printing plate with two reference marks arranged in approximately diagonally opposite areas of the printing plate,

FIG. 3 a schematic view of a reference mark with twelve reference fields, and

FIG. 4 a partial view of a reference mark with different, structured reference fields.

### DETAILED DESCRIPTION OF THE PREFERRED EMBODIMENTS

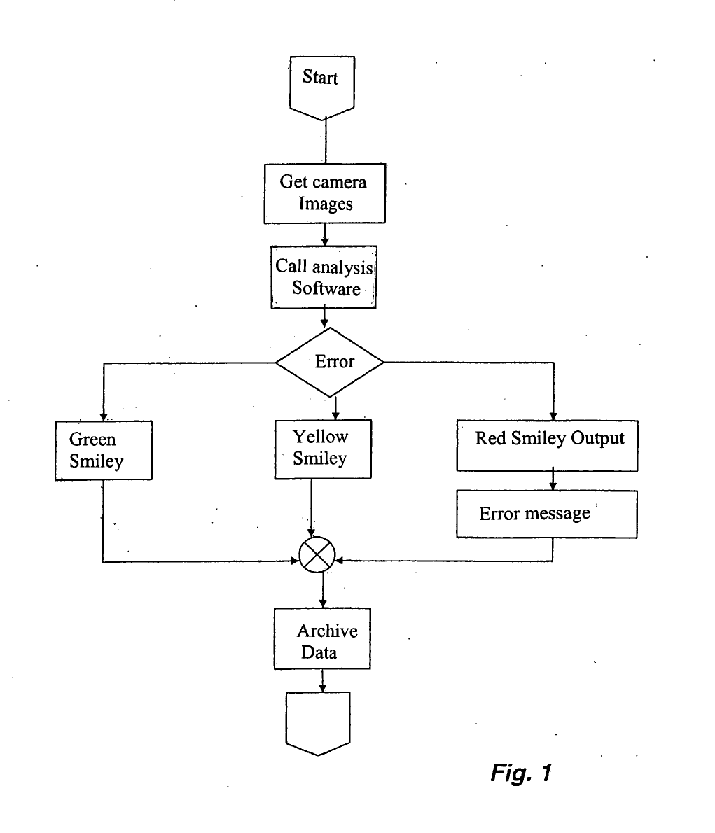

FIG. 1 shows a sequence or flow chart for the method according to the invention.

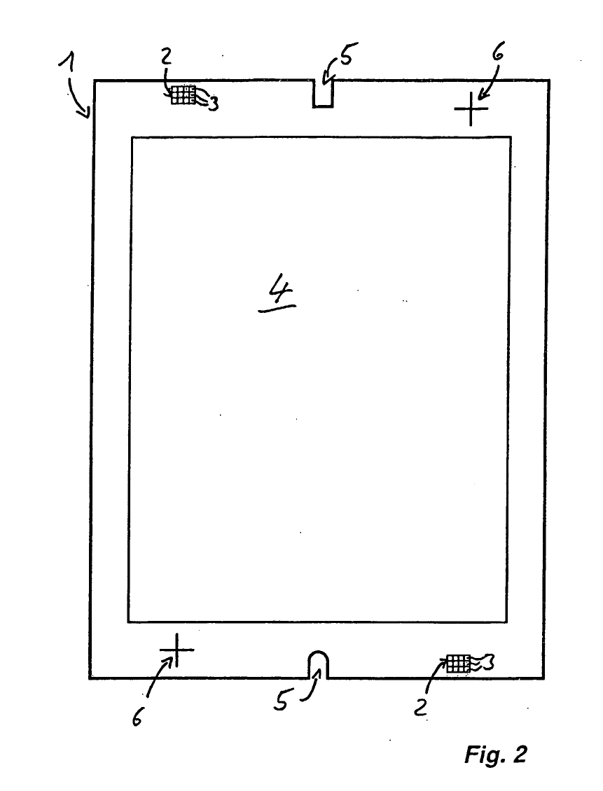

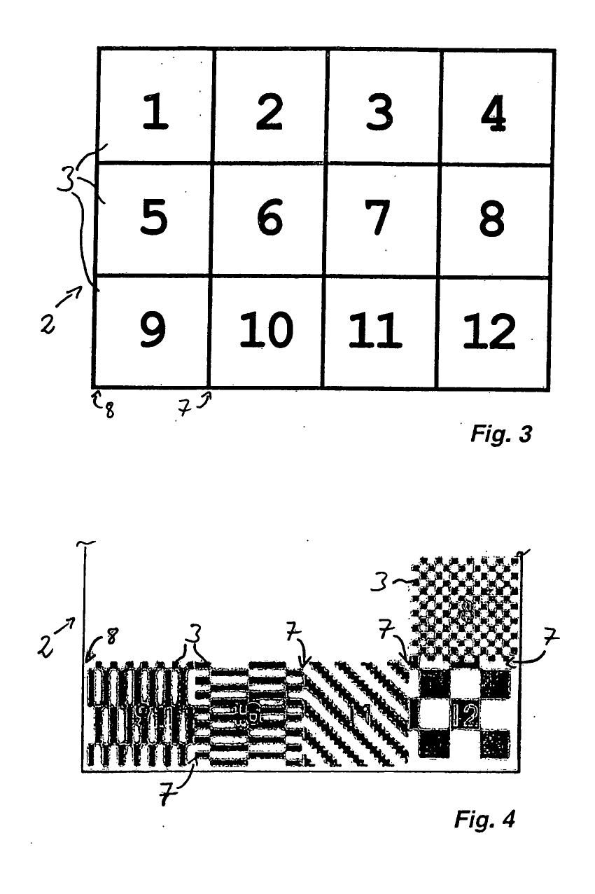

After the start of the test routine, images of the reference marks 2 (FIG. 2) are recorded by means of a camera or similar detectors. These images are converted into electrical signals and evaluated by means of analysis software of the evaluation device. Here, the measured values of individual reference fields 3 (FIGS. 3, 4) of the reference marks 2 are taken into account individually and in combination with each other and compared with desired values or stored profile curves. Depending on each measured value, a corresponding report is displayed on a display unit with reference to an error-diagnosis program. This report can be realized as plain text or symbolically, for example, a green smiley indicates no errors, a yellow smiley indicates deviations from the desired values that are still within permitted tolerance limits, and a red smiley indicates a deviation outside of the tolerance thresholds. In the latter case, preferably an explanatory output is provided, by means of which measures can be taken to correct the errors.

The measured values and also the analysis data determined from these values are then archived in a data memory, in order to allow measurement series to be created and in order to allow history data, for example, of a completed series, to be retrieved.

FIG. 2 shows a printing plate 1 with two reference marks 2 arranged in approximately diagonally opposite areas. By means of this arrangement of the two reference marks 2, the quality of the plate imaging of the printing plate 1 can be determined in the top, bottom, left, and right areas of the printing plate 1. Thus, not only a spot quality check is possible, but instead a check over the entire plate area. If necessary, other reference marks can be provided (for example, along the plate edges), in order to allow an even more finely tuned quality check. The reference marks 2 are arranged outside of the printing area 4 of the printing plate 1, so that these are not imaged in the printed image, for example, a page of a newspaper.

For setting the stamping marks 5, which are required for exact positional setting of the printing plate 1 in the printing press, or for folding the plate edges with the stamping marks 5, the printing plate 1 is aligned by means of the positioning cross 6. After this alignment, the reference marks 2 can also be detected, in order to eliminate another aligning of the printing plate 1.

The reference marks 2 are shown in more detail in FIGS. 3 and 4. The reference mark 2 from FIG. 3 has twelve reference fields 3, which are numbered with the numbers 1 to 12 in FIG. 3. Each individual reference field 3 can be either a tone value reference field or a structured reference field.

Tone value reference fields have a defined percentage surface area coverage. Each tone value reference field has a corresponding desired value. If the measured tone value deviates from the desired tone value, a conclusion can be drawn on the quality of the plate imaging. Here, tolerance limits can be set, within which the measured value is not considered to be a defect.

In FIG. 4, a reference mark 2 is shown in partial view, in which a few of the reference fields 3 are embodied as structured reference fields. The structures are each oriented according to pixels and composed of different pixel structures. Here, two different pixel types are used, in the shown example, the pixels have either the tone value 0% (white) or 100% (black). In principle, however, other combinations of different tone or also color values (e.g., cyan, magenta, yellow, and black) are also possible.

The fields 8 and 12 each have a checkerboard pattern, wherein the individual fields each consist of one pixel (reference field “8”) or four pixels (reference field “12”). The reference fields “9” and “10” have longitudinal and transverse lines, respectively, and the reference field “11” has diagonal lines that are each two pixels wide.

Through the combination of regular, irregular, symmetric, and asymmetric structures, also in connection with the evaluation of the tone value fields, a very precise diagnosis can be made on the appearance of errors and their cause in the printing plate processing device.

In the measured value analysis, the transition regions 7 of adjacent reference fields 3 and/or the edge regions 8 of individual reference fields 3 can also be taken into account advantageously. These regions 7, 8 practically form additional auxiliary reference fields, which can further improve the error diagnosis. Also, conclusions can be drawn from combinations of reference fields that are relevant for determining the quality.

As evaluation criteria, in particular, the surface area coverage in percent, the grid width, the grid angle, the edge zone, the homogeneity (anodized 0%, layer 100%), the change in color, the flank or the flank angle, or the gray value, or two or more of these properties, can be used. Through combinations of these measured values from individual and/or multiple reference fields 3, as well as the transition and edge regions 7, 8, a very precise error diagnosis is possible.

A reference mark can be provided with reference fields, for example, according to the following table, with the measured values of the individual reference fields able to be evaluated according to the criteria given in the table.

| Corresponding | | | |
|---|---|---|---|
| reference | Type of | | |
| number | reference | Evaluation | Evaluation |
| in FIG. 3 | field | 1^{st} phase | 2^{nd} phase |
| 1 | Grid field 98% | Dots present/not | |
| | | present | |
| 2 | Grid field 90% | FD, RZ, RWE, RWI | HO, FA, FLS |
| 3 | Grid field 30% | FD, RZ, RWE, RWI | HO, FA, FLS |
| 4 | Grid field 50% | FD, RZ, RWE, RWI | HO, FA, FLS |
| 5 | Grid field 2% | Dots present/not | |
| | | present | |
| 6 | Grid field 10% | FD, RZ, RWE, RWI | HO, FA, FLS |
| 7 | Grid field 70% | FD, RZ, RWE, RWI | HO, FA, FLS |
| 8 | Checkerboard | | GW, HO, FA, |
| | 1 × 1 pixels | | FLS |
| 9 | Lines | | GW, HO, FA, |
| | 5 × 1 pixels | | FLS |
| 10 | Lines | | GW, HO, FA, |
| | 1 × 5 pixels | | FLS |
| 11 | Lines diagonal | | GW, HO, FA, |
| | 2 pixels | | FLS |
| 12 | Checkerboard | | GW, HO, FA, |
| | 4 × 4 pixels | | FLS |

The abbreviations have the following meanings:

| | |
|---|---|
| FD | Surface area coverage in % |
| RWE | Grid width |
| RWI | Grid angle |
| RZ | Edge zone |
| HO | Homogeneity, anodize 0%, layer 100% |
| FA | Color change |
| FLS | Flank/angle |
| GW | Gray value |

The reference marks 2 shown in the figures each have 12 reference fields 3. However, according to the field of application and the desired depth of error diagnosis, reference marks with fewer or more reference fields can also be provided. It is also possible to provide a basic structure with 12 reference fields, wherein, however, not all of the fields are occupied by a tone value or a structure and thus are not used for the evaluation.

The composition of pixel and tone value fields can be changed from printing plate to printing plate, preferably in a repeating rotation, that is, for example, reference marks varying on successive printing plates can be used, which permits additional conclusions to be drawn from the comparison. For example, four different reference marks can be used, with a first printing plate being provided with a first reference mark variant, the second printing plate being provided with a second reference mark variant, the third printing plate being provided with a third reference mark variant, and the fourth printing plate being provided with a fourth reference mark variant. The next printing plate is then provided again with the first reference mark variant and so forth.

Likewise, it is also conceivable to provide reference marks (wedges) with fewer than twelve reference fields, especially when only a little space is available for the reference marks on the printing plate. On the other hand, for an equal size of the reference marks, the individual reference fields can have larger sizes, which enable the use of lower resolution cameras as sensors. Nevertheless, through the combination of measured values from the individual reference fields, sufficiently accurate information on possible error sources is possible.

1. Device for determining the quality of imaging of printing plates, comprising an optoelectronic sensor for detecting a reference mark (wedge or block), which is arranged on the printing plate within or outside of a printing area and which has different reference fields, as well as an evaluation device for evaluating measured values detected by the sensor, the sensor is designed for detecting at least two reference marks arranged on the printing plate, wherein the reference marks each have a reference field combination made from at least one tone value reference field and at least one structured reference field, or at least one of the reference marks has at least one tone value reference field and at least an other one of the reference marks has at least one structured reference field.

2. Device according to claim 1, wherein the two or more reference marks are identical in terms of the reference fields.

3. Device according to claim 1, wherein the two or more reference marks are different in terms of the reference fields.

4. Device according to claim 1, wherein two of the reference marks are provided, which are spaced apart from each other in a direction of advance or processing of a printing plate processing device producing the plate imaging and are arranged on at least approximately diagonally opposite areas of the printing plate.

5. Device according to claim 1, wherein the sensor has a number of detectors corresponding to a number of the reference marks of the printing plate.

6. Device according to claim 1, wherein the evaluation device evaluates combinations of measured values from individual ones of the reference fields that are preset or that can be preset from one or more of the reference marks and the evaluation device has a diagnosis system for diagnosing possible causes of errors depending on the measured values or the combination of measured values.

7. Device according to claim 6, wherein the evaluation device has a display or a similar output unit for displaying the measured values or analysis or diagnosis data determined with reference to the measured values.

8. Device according to claim 7, wherein the evaluation device has a data memory for the determined measured values and/or the analysis data determined from the values.

9. Device according to claim 1, wherein the evaluation device has a desired value memory for different printing technologies and that an input device is provided for selecting and setting desired values to be used by the evaluation device.

10. Device according to claim 1, wherein the device is integrated into a printing plate processing device.

11. Device according to claim 1, wherein the evaluation device has a signal output connected to the printing plate processing device for stopping the printing plate processing device.

12. Device according to claim 1, wherein the structured reference fields have regular, irregular, symmetric, and/or asymmetric figure patterns.

13. Device according to claim 1, further comprising it has at least one additional optoelectronic sensor for detecting at least one identification mark, which is arranged on the printing plate and which is provided in plain text or in coded form, the optoelectronic sensor or sensors are adapted for detecting at least one such identification mark.

14. Method for determining the quality of imaging of printing plates, comprising: optically detecting a reference mark on a printing plate and comparing resulting measured values with desired values, the measured values are detected from at least two of the reference marks with at least one tone value field and at least one structured field and absolute measured values of the reference marks are stored and compared with desired values stored in an evaluation device.

15. Method according to claim 14, further comprising analyzing the measured values of several printing plates detected one after the other in a time-value profile.

16. Method according to claim 14, further comprising comparing the measured values or combinations of at least two measured values automatically with values from a diagnosis table for determining possible causes of poor quality in the plate imaging of the printing plate.

17. Method according to claim 14, further comprising outputting the measured values and/or diagnosis data determined with reference to the measured values on an output unit.

18. Method according to claim 14, wherein information from edge areas of adjacent reference fields and/or from the edges of the reference fields is also used for determining a quality of the plate imaging by the printing plates.

19. Method according to claim 14, wherein the device includes an optoelectronic sensor for detecting a reference mark (wedge or block), which is arranged on the printing plate within or outside of a printing area and which has different reference fields, as well as an evaluation device for evaluating measured values detected by the sensor, the sensor is designed for detecting at least two reference marks arranged on the printing plate, wherein the reference marks each have a reference field combination made from at least one tone value reference field and at least one structured reference field, or at least one of the reference marks has at least one tone value reference field and at least an other one of the reference marks has at least one structured reference field.

20. Reference mark comprising different reference fields for determining a quality of imaging of printing plates, including a reference field combination made from at least one tone value field and at least one structured field.

21. Reference mark according to claim 20, wherein edge regions of individual ones of the reference fields and/or transition regions of adjacent ones of the reference fields form additional auxiliary reference fields.

22. Reference mark according to claim 20, wherein the reference mark has multiple reference fields arranged as a matrix.

23. Reference mark according to claim 20, wherein the reference mark has a combination of structured reference fields with regular, irregular, symmetric, and/or asymmetric figure patterns.

24. Reference mark according to claim 20 wherein the reference mark has a width of approximately 5 mm to 7 mm and a height of approximately 4 mm to 5 mm.

25. Reference mark according to claim 20, wherein the reference mark has an identification mark for unique identification of a corresponding printing plate or an identification mark is allocated to the reference mark.

26. Reference mark according to claim 20, wherein the identification mark is a plain text label or a coded label.

27. Printing plate with at least two reference marks, comprising:
a plate and imaging located thereon; and
at least two reference marks arranged on the printing plate, wherein the reference marks each have a reference field combination made from at least one tone value reference field and at least one structured reference field, or at least one of the reference marks has at least one tone value reference field and at least an other one of the reference marks has at least one structured reference field.
